(19) United States
(12) Patent Application Publication
(10) Pub. No.: US 2011/0267469 A1
(43) Pub. Date: Nov. 3, 2011

(54) SYSTEM AND METHOD FOR OVERLAYING DATA ONTO IMAGES OF A TRAFFIC ENFORCEMENT CAMERA

(75) Inventors: Vorn MOM, Providence, RI (US); Jigang Wang, Scottsdale, AZ (US)

(73) Assignee: American Traffic Solutions, Inc. of Kansas, Scottsdale, AZ (US)

(21) Appl. No.: 13/015,625

(22) Filed: Jan. 28, 2011

Related U.S. Application Data
(60) Provisional application No. 61/298,950, filed on Jan. 28, 2010.

(51) Int. Cl. H04N 7/18

(52) U.S. Cl. 348/149; 348/E07.085

(57) ABSTRACT

A system and method for overlaying data, in the form of a databar, onto image frames that collectively show a video of a traffic violation event. In the system and method, a digital video of the violation event is first captured, where the video is comprised of a plurality of image frames of the violation event. Pertinent data corresponding to the violation event is determined and then this data is overlaid onto each image frame as a databar. In this manner, a single integrated file showing an image frame, having the databar overlaid thereon, may be stored in a database for evidentiary purposes to be reviewed by traffic enforcement personnel.

### CROSS REFERENCE TO RELATED APPLICATIONS

This application claims the benefit of U.S. Provisional Application No. 61/298,950, filed Jan. 28, 2010, the content of which is incorporated herein by reference thereto.

### COPYRIGHT & LEGAL NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### FIELD OF THE INVENTION

The present invention relates generally to the field of automated systems and methods for traffic violation enforcement and more particularly to the acquisition of video images in connection of the video files in connection with violations.

### BACKGROUND OF THE INVENTION

In the field of traffic enforcement, there exist a variety of systems and methods for capturing data related to a traffic violation event, such as the capture of the violation event, as well the capture and delivery of other information about the traffic violation itself. The violation can result from the act of driving through a red light or a stop sign, or exceeding the posted speed limit, among others.

It is desirable to provide a system and method for automatically tracking, detecting, capturing and storing these violation events via roadside computers and/or imaging devices. For example, when tracking a red light violation, it is desirable to create a video of the violation, as well as any relevant information such as the location of the violation, the date, the duration of the violation, information identifying the violating vehicle and/or operator and any other pertinent information useful in proving that the violation occurred. According to current traffic enforcement systems and methods, this information is captured, the files becomes disassociated and are then sent individually (i.e. two or more separate files) to a database that stores the violation information.

Reference is now made to FIG. 1, a block diagram showing an overview of the network architecture for a prior art traffic enforcement system 100, in which a plurality of imaging devices 102 communicate over the network 104 to a server 106 that transmits the violation data to a database 108. According to the system 100, an imaging device is a remote camera sensor (typically located along a span of roadway or intersection) that captures a video of the traffic violation in a digital video file, as well as any other pertinent information relating to the violation in a different file. However, these two files become disassociated from each other, according to prior art systems and methods. That is, the video file is transmitted via data stream 110, and the other file, containing textual information, is transmitted via data stream 112.

These two disassociated files of information are transmitted over the network 104 to the server 106 which stores the violation information as two related but disassociated digital files, one containing a video of the violation event, is transmitted via data stream 114 and the other, containing the other pertinent textual information to identify the violation event, is transmitted via data stream 116. The server 106 stores the video file in the database 108 via data stream 118, and the text file, disassociated from the video file, is transmitted via data stream 120 to be stored in database 108.

It is generally disadvantageous to provide two files that become disassociated as they are transmitted to and stored in appropriate databases, as it is possible for the files to become separated during handling. Such errors can become particularly problematic in the area of law enforcement, where the integrity of the evidentiary record is critical. Moreover, the creation and storage of separate files (the video file and the associated violation event file), creates security problems as, according to prior art systems, the two files become disassociated to be re-associated at a later point. One general disadvantage of such a system is that when the files become re-associated, it is entirely possible for a video file for one violation event to become associated (incorrectly, for example) with information relating to another violation event, or vice versa. Such an error, inherent in the prior art systems, could be devastating for several reasons. It could incorrectly associate a video file with a completely unrelated text file. This could result in an innocent automobile operator being charged with a violation that another operator committed.

Accordingly, it is desirable to provide a system and method for providing information relevant to a particular violation event, such that the video file and its related text file may be transmitted to and stored in a database as one consolidated file, as opposed to two individual files that may become disassociated. It is further desirable to provide a system and method in which each image frame of the video file has imprinted thereon the information associated with the violation. This would improve automated traffic enforcement security by having the violation information directly on each frame of the video. In that manner, one file may be sent to the database and stored as opposed to two individual files. Such an integrated file should allow for the ready review of all necessary information with respect to a video showing the violation event.

### SUMMARY OF THE INVENTION

This invention overcomes disadvantages of the prior art by providing a system and method for the automated generation of traffic enforcement evidence and other information that is overlaid onto a single reviewable video file of the violation event. In general, the invention herein provides a system and method for automatically predicting, tracking and capturing traffic violation events in which the resulting data stored in the database is one integrated data file containing all of the information pertinent to the violation, so as to be used to prove that the violation occurred, and avoid the risk that the data will become disassociated from the video file. This violation data can be presented as a databar that appears on each frame of the violation video.

In an illustrative embodiment, there is provided a system and method for capturing pertinent information related to a traffic violation event. More particularly, the system and method captures and stores a video file of the traffic violation event, particularly formatted so as to include textual information about the violation encoded therein. The method first monitors a particular roadside area for traffic violations. For example, there may be a plurality of video cameras that each have a respective view of an intersection that is being monitored for, for example, red light violations. Next, a video file of the violation event is captured, as well as a text file containing information about the violation itself. This text file may include identifying information about the violating vehicle and/or operator and information about the violation itself, such as duration of the yellow (amber) light or red light. The video file that is captured is a digital datastream comprising a plurality of individual image frames. A databar engine then implements the databar application to overlay a databar onto each image frame of the video file, which contains the pertinent information in a form that is readable, but does not asbscure the underlying video detail. For example, the databar can be placed at the margin of the video window. This databar is imprinted on the image frame and includes the information contained in the text file that was transmitted to the databar engine.

In an illustrative embodiment, the databar includes information related to the violation event, including, for example, the date and time of the event, the intersection and lane number (if applicable), the time elapsed since a change in light color and a unique identification number for identifying the event.

### BRIEF DESCRIPTION OF THE DRAWINGS

The invention description below refers to the accompanying drawings, of which:

FIG. 1, previously described, is a block diagram illustrating a prior art automated traffic enforcement system;

FIG. 2 is a block diagram illustrating the overall interaction of the illustrative automated traffic enforcement system in which the imaging devices perform the encoding and compression of the video file;

FIG. 3 is a block diagram illustrating the operation of the databar engine of the illustrative automated traffic enforcement system;

FIG. 4 is a flow diagram illustrating the overall steps to the illustrative automated traffic enforcement system:

FIG. 5 is a flow diagram illustrating the steps taken by the MPEG4 encoder application in encoding and compressing the video file; and

FIG. 6 is an exemplary image frame of the video file displaying the databar containing violation information laid thereon according to the illustrative automated traffic enforcement system.

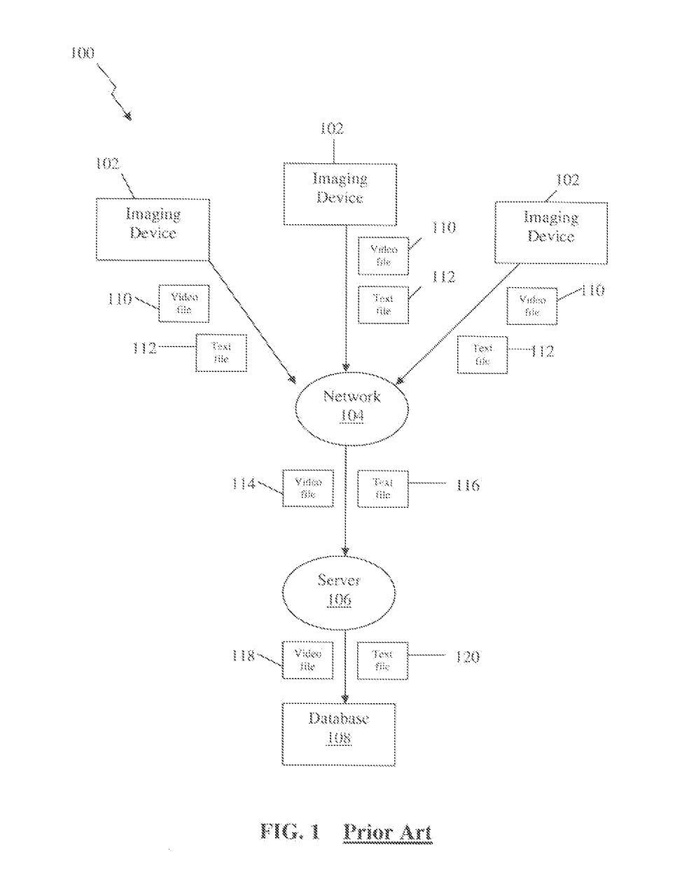

### DETAILED DESCRIPTION OF THE PREFERRED EMBODIMENT(S)

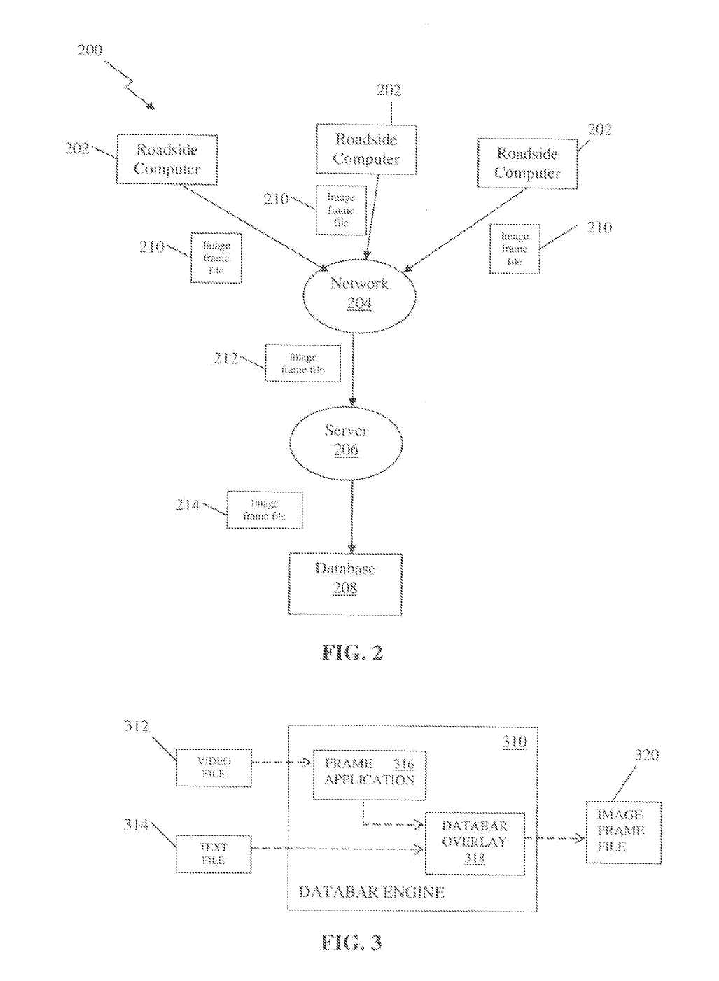

In accordance with the present invention there is provided an automated traffic enforcement system for the prediction, tracking and capturing of information related to a traffic violation event. FIG. 2 is a block diagram showing an overview of the network architecture for an automated traffic enforcement system 200 according to an illustrative embodiment of this invention. The depicted example of the automated traffic enforcement system 200 is arranged so that a plurality of roadside computers 202 communicate over the network 204 to a server 206 to perform automated traffic enforcement. The automated traffic enforcement system 200 can comprise any acceptable computer or computing system running software applications that include a computer readable medium which executes program instructions. The network 204 may be any communication system used to transmit or receive data, for example, a local area network or the broad, worldwide Internet. According to the present invention, the server 206 is in communication with a database 208 that stores the violation information.

As shown in FIG. 2, each roadside computer 202 predicts, tracks and captures information from a traffic violation, such as a red light violation, for example. Generally, the system employs at least one prediction unit responsible for predicting potential traffic violations and at least one violation unit in communication with the prediction unit for recording the violations. A prediction unit processes each video captured by a prediction camera so as to identify predicted violators. The prediction unit then send a signal to the violation unit if it finds a high probability of violation events. The violation unit then records the high probability events. For a more detailed description of a process by which the system performs the prediction, tracking and capturing of traffic violation information, refer to commonly assigned U.S. Pat. No. 6,754,663, entitled VIDEO-FILE BASED CITATION GENERATION SYSTEM FOR TRAFFIC LIGHT VIOLATIONS, which is expressly incorporated by reference herein. The system may also employ a virtual violation line, which employs a filter to eliminate potential violations that are not as likely. For a more detailed description of this implementation, refer to commonly assigned U.S. Pat. No. 6,950,789 entitled TRAFFIC VIOLATION DETECTION AT AN INTERSECTION EMPLOYING A VIRTUAL VIOLATION LINE, which is also expressly incorporated by reference herein.

In an illustrative embodiment, the roadside computers 202 perform the capture of the roadside violation and encode the video data into MPEG AVI files. A variety of alternative file types can be employed in alternate embodiments. For example, encoding into any of the following file formats, among others, may be appropriate: 3GPP Multimedia File, Advanced Systems Format File, Microsoft ASF Redirector File, Audio Video Interleave File, Flash Video File, Apple QuickTime Movie, MPEG-4 Video File, MPEG Video File, Real Media File, Flash Movie, DVD Video Object File, and Windows Media Video File. AVIsynth, available from a variety of open-source Internet-based distributors, is an exemplary application that performs the conversion into proper format and then stores it in the database, as will be described in greater detail hereinafter. The roadside computer 202 may be an imaging device having basic functionality to capture the video and other text information, or a fully capable computing system (e.g., a PC) that captures and processes the information necessary to properly capture the violation in accordance with the illustrative embodiment.

Each of the roadside computers 202 captures violation event information, including a video of the violation as well as any information necessary to prove that the violation occurred. This information includes the time, the location, information related to the violating vehicle and/or operator and information about the violation itself, such as the length of yellow (or amber) light, or the length into the red phase of light. This information is automatically generated by the computer according to conventional techniques.

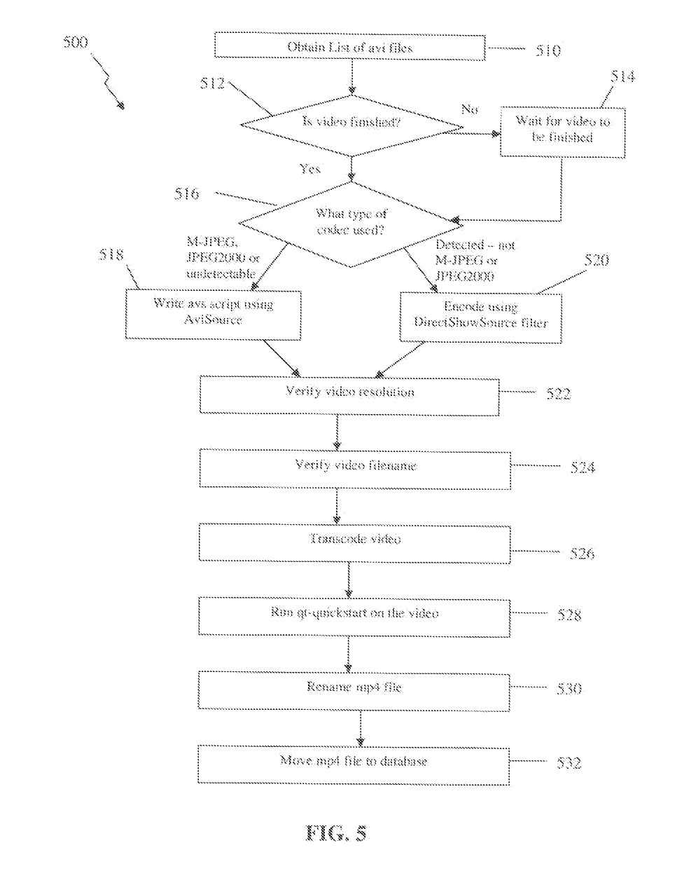

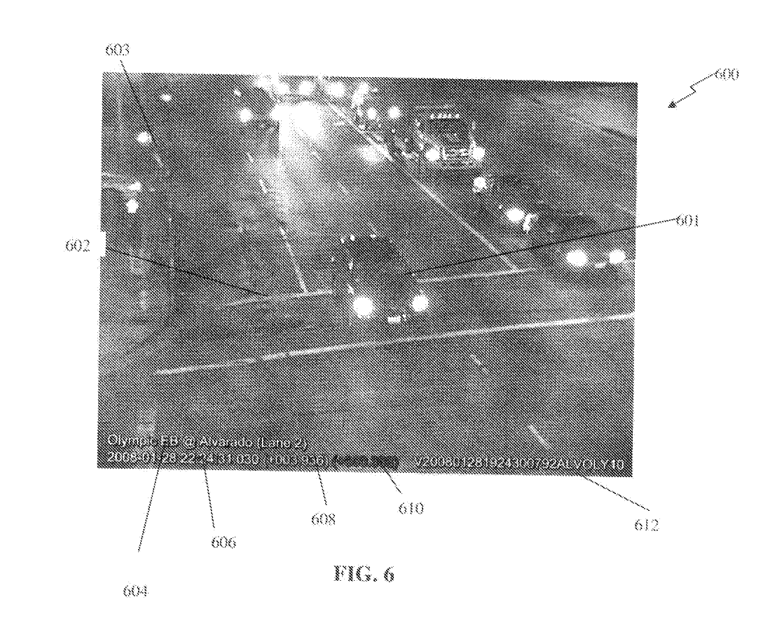

In overview, the video file is broken down, frame-by-frame, such that each frame may be treated as an individual piece of evidence by law enforcement personnel. In accordance with the illustrative automated traffic enforcement system, each frame is then overlaid with a novel alphanumeric databar that includes the additional pertinent information about the violation, using predetermined overlay techniques, as will be described in greater detail below in reference to FIG. 3. The image frame is encoded and compressed according to the steps illustrated in FIG. 5, as will also be described in greater detail hereinafter. The result is an exemplary image frame 600 of the video file having the novel databar overlaid thereon, as shown in FIG. 6 (described below).

With further reference to FIG. 2, the image frame file containing one frame of the video of the traffic violation, as well as the corresponding information about the violation itself imprinted thereon, is transmitted over the network 204 via a data stream 210 and then to the server 206 via the data stream 212. In this manner, only one integrated data file showing one frame of the violation event video with a databar imprinted thereon is transmitted via the data stream 214 to the database 208 so as to be stored. The integrated data file is sent to the server 206 through the network 204 as one single file, as opposed to two or more disassociated files containing the video and the violation event information separately, thereby further improving security measures by ensuring the video image and the corresponding violation information remain together and do not become disassociated. In this manner, the security of automatic traffic enforcement system is improved by overlaying a databar containing the pertinent information onto the frame of the violation event video file.

The system and method implements technology that prevents the databar from being tampered-with. In this manner, it will be known if a person attempts to modify the video file. This also further improves security for the traffic enforcement industry by permanently merging the textual violation information with the video file, by imprinting it on each frame of the video file. This implementation is accomplished as the integrated data file is encrypted such that if the file is tampered with, it will become evident and is not accepted according to the illustrative system. Preferably, after automatically overlaying and before allowing access by traffic enforcement personnel to the integrated data file, the file is stored with write protection (as a read-only file) and/or in encrypted form.

Reference is now made to FIG. 3, showing a block diagram of the overall architecture for the databar engine 310 according to the illustrative automated traffic enforcement system. The databar engine 310 is a software application of the system and may include a processing block that writes the violation information directly onto each frame. According to the illustrative system, pertinent violation even information is imprinted onto each frame of the violation event video. In operation, a separate video file 312 and text file 314 are input to the databar engine 310 to be properly formatted and overlaid with a databar containing information specific to the particular violation. The databar engine 310 may implement a frame application 316 that parses the video into individual frames so they may each be overlaid with a databar (at block 318) containing the information from the text file stamped directly on the frame.

The databar, consisting of alphanumeric information relating to the violation event, is overlaid on the frame using conventional overlay techniques for imprinting an alphanumeric databar onto an image. The result is an image frame file 320, containing a frame of a video of the violation event having the pertinent violation information imprinted thereon. As previously mentioned, an exemplary image frame file is shown in FIG. 6, which will be discussed in greater detail below.

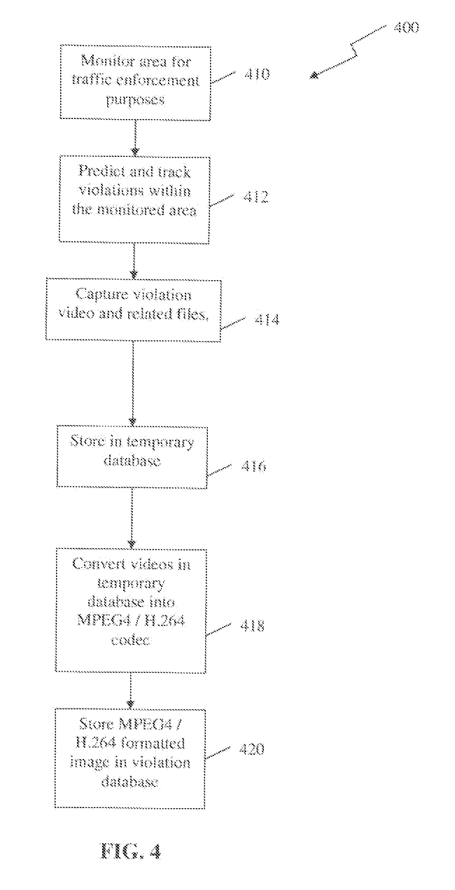

FIG. 4 is a flow diagram 400 illustrating the overall steps of the illustrative traffic enforcement system. At step 410, the roadside computers 202, illustrated in FIG. 2, monitor a particular area for traffic enforcement purposes. Then, at step 412, the roadside computer predicts and tracks violations within the monitored area. As previously mentioned, for a more detailed discussion of the methods and systems for performing the prediction and tracking of traffic violation events, refer by way of example to commonly assigned U.S. Pat. Nos. 6,754,663 and 6,950,789, as previously described. In an illustrative embodiment, a predetermined area is monitored for potential violations and the system obtains pertinent information relating to the violation event by receiving a signal that a change has occurred, such as the signal that the light has changed color. Receiving the signal allows the system to determine whether a violation has occurred.

Once a violation has been detected, the system captures the violation event video file and other pertinent information as a data file at step 414. These files are stored as two individual and separate files to be later combined into a single integrated data file containing a single frame of the violation event video having the databar overlaid thereon, as will be described in greater detail hereinafter. The video is then converted into proper codec at step 418, into MPEG4/H.264 format, a standard that is used to compress digital video and audio data. The compression is performed in accordance with conventional techniques. This is a desirable format for the violation videos as it is the best balance in size and quality. Compressing the violation videos allows more frames per second to be passed, for example, from a camera to the receiving equipment. MPEG4/H.264 format is a standard for this type of compression.

Referring further to FIG. 4, at step 420, the MPEG4/H264 formatted image frame is stored in the violation database (i.e., database 208 of FIG. 2). In this manner, each piece of evidence—each piece being one image frame from the video file—is stored in the database. Each frame includes the textual information about the violation thereon.

Reference is now made to FIG. 5, a flow diagram 500 illustrating the steps taken by the MPEG4 encoder application in encoding and compressing the video file. At process step 510, the process 500 obtains a list of video files in .avi format. Next, at step 512, the process 500 checks to determine if the video file is finished recording. If it is not, it moves to step 514 to wait for the video to be completed.

Once the video has finished recording, at step 516 the process 500 determines which type of codec has been used. This is done through an application available under the name MediaInfo, which is available from a variety of internet-based sources. This application employs the function DirectShow to get information about the video, such as codec and video resolution. If it is M-JPEG. JPEG2000 or an undetectable codec, the process 500 performs step 518 to write the avs script (encode) using the application AviSource (part of the application set AviSynth). If the codec may be detected, but is not M-JPEG or JPEG2000 codec, then the process performs step 520 to encode using a DirectShowSource filter.

As shown in FIG. 5, the process 500 then runs process step 522 to verify the video resolution. If it is greater than 640×480 ppi (pixels per inch), then a single-pass quality 20 (configurable) should be used. A video resolution higher than 640×480 ppi is typically associated with a video from a Nikon™ digital camera, as they are typically higher resolution so as to capture a violator's face or the license plate. Accordingly, these videos will be encoded at 20 kHz to ensure proper formatting. In a preferred embodiment, videos with such a high video resolution (greater than 640×480) should be compressed less to ensure maximum image quality for processing.

At step 524, the video filename is verified to determine if it matches a file filter. If it matches the filter, compression settings for that file filter are used. It is possible that a single camera at the roadside may produce poor video (for example, if there are uncontrollable issues such as a foggy lens or the camera is placed at an obscured location). It is desirable for these videos to be encoded with higher quality to retain as much detail as possible. However, it is typically unnecessary to convert all cameras at this quality level. The system resolves this concern by allowing each camera to define a specific compression setting that overrides the default setting. Notably, each video filename contains a signature as to which camera is used. If the filename matches the signature assigned to a particular intersection, the compression settings override any other setting.

Next, at step 526, the process 500 transcodes the video. There are two external software applications that may be used to transcode the video: AviSynth and x264 (available from a variety of Internet-based open-source distributors). These applications create a script for which type of video format to be used. The video is loaded and then the format is changed to the required format for the appropriate application.

The process 500 then runs the application qt-quickstart on the video at step 528. The MPEG4 container normally stores important playback information such as the frame rate and frame size, at the end of the file. The process moves that information to the beginning of the file to allow the video to play progressively in a commercially distributed media player such as Quicklime or Flash. In this manner, users on a slow connection can begin watching the downloaded part of the video while the remainder of the video is being downloaded. It is desirable for this application to be run roadside because it does alter the video and thus, if done after it is transmitted from the roadside computers, the database will not accept the file because it will have been altered.

Next, at step 530, the process 500 renames the mp4 file to Avi, and then at step 532 the file is moved into the database to be used for evidentiary support in the traffic enforcement industry.

Reference is now made to FIG. 6, an exemplary image Frame 600 of the video file displaying the databar containing violation information overlaid thereon. The image frame 600 is one frame of a video of a violation event, depicted here as a vehicle 601 crossing the stop line 602 after the light 603 has already turned red. According to the illustrative system and method, the databar overlaid on the image frame 600 contains pertinent information about the violation event. One piece of information displayed in the databar is the location of the violation event (604), which contains, in this exemplary image frame 600, the intersection and lane number at which the violation occurred. The databar also displays a date and time stamp (606) in year-month-date and hour-minute-second format. This particular image frame, as it is showing a red light traffic violation, also displays the offset in thousandths of a second from the start of the amber or yellow phase (608). This shows the lapse in time since the light has turned amber. The databar also displays the lapse in time since the light has turned red (610) in thousandths of a second. And finally, the databar displays a unique ID (612) for identifying the violation event.

The foregoing has been a detailed description of illustrative embodiments of the invention. Various modifications and additions can be made without departing from the spirit and scope of this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. For example, the violation event described herein has been related primarily to a vehicle traveling through an intersection after the traffic light has already turned red. However, it is expressly contemplated that this has application in all areas of traffic enforcement, including, but not limited to, illegally traveling through a stop sign without stopping, or even speeding violations. Also, the databar illustrated herein may contain additional information pertinent to the violation event, such as the vehicle license plate if available, or other identifying information. The databar may also include less information, if desired. Likewise the types of information, presentation and location of the image frame are highly variable. In addition, the term “databar” can refer to a plurality of data regions at predetermined locations on the frame. In general, the system and method herein can be implemented as hardware, software consisting of a computer-readable medium executing program instructions, or a combination of hardware and software. Accordingly, this description is meant to be taken only by way of example, and not to otherwise limit the cope of this invention.

What is claimed is:

1. A system for overlaying data onto an image of a traffic violation event, the system comprising:
a plurality of roadside computers in communication with a system server over a network that capture a digital video of the violation event and other data pertinent to the violation event, wherein the video is of a particular file type, and wherein roadside computers automatically overlay a databar onto each frame of the violation event, the databar containing the data pertinent to the violation event, thereby creating a single integrated image frame file; and
a system server adapted to receive the image frame file from the roadside computers and transmit the image file frame through the network to be stored in a violation event database, to be used by traffic enforcement personnel.

2. The system of claim 1 further comprising a temporary database in which the data pertinent to the violation event, is stored such that it may be overlaid in the form of a databar onto each image frame.

3. The system of claim 1 wherein the roadside computers are connected to a prediction unit and encoded instructions operating on a processor execute a prediction routine which predicts whether a violation may occur prior to capturing the digital video.

4. The system of claim 1, wherein the file type is selected from a group of file types consisting of MPEG AVI, AVISynth, 3GPP Multimedia File, Advanced Systems Format File, Microsoft ASF Redirector File, Audio Video Interleave File, Flash Video File, Apple QuickTime Movie, MPEG-4 Video File, MPEG Video File, Real Media File, Flash Movie, DVD Video Object File, and Windows Media Video File.

5. The system of claim 1, wherein the pertinent data includes one selected from a group of pertinent data consisting of time, location, information related to the violation vehicle or or operator, information related to the vehicle itself.

6. The system of claim 1, wherein, prior to storing the video file, the file is compressed.

7. The system of claim 1, wherein, after automatically overlaying and before allowing access by traffic enforcement personnel thereto, encoded instructions executed on a processor are adapted to store the integrated image frame with write protection and/or encryption.

8. A method for overlaying data onto an image of a traffic violation event, the method comprising:
capturing a digital video of the traffic violation event, the video being of a particular file type and comprising a series of frames that collectively form a digital video file of the traffic violation event;
automatically ascertaining pertinent data relevant to each frame of the video such that the data is specific to a particular moment of the violation event video, represented by the individual frame; and
automatically overlaying the pertinent data in the form of a databar onto its respective frame, thereby creating an integrated image frame file showing an image frame having the databar overlaid thereon.

9. The method of claim 8, further including the step of predicting the violation prior to the capturing step.

10. The method of claim 8, wherein the file type is selected from a group of file types consisting of MPEG AVI, AVISynth, 3GPP Multimedia File, Advanced Systems Format File, Microsoft ASF Redirector File, Audio Video Interleave File, Flash Video File, Apple QuickTime Movie, MPEG-4 Video File, MPEG Video File, Real Media File, Flash Movie, DVD Video Object File, and Windows Media Video File.

11. The method of claim 8, wherein the pertinent data includes one selected from a group of pertinent data consisting of time, location, information related to the violation vehicle or or operator, information related to the vehicle itself.

12. The method of claim 8 further comprising the step of storing the pertinent data into a temporary database after it is ascertained, such that it may be formatted into a databar that is overlaid on the image frame.

13. The method of claim 8, wherein, prior to the step of storing the video file, the file is compressed.

14. The method of claim 8, wherein, after automatically overlaying and before allowing access by traffic enforcement personnel thereto, storing the integrated image frame with write protection and/or encryption.

15. The method of claim 8 wherein the databar is overlaid onto at least one image frame in a bottom margin of the frame.

16. The method of claim 8, wherein the databar includes a time and date stamp identifying the event.

17. The method of claim 8 wherein the traffic violation event is selected from a group of events consisting of a red light violation, a speed limit violation, a road weight violation, driving in an exclusion zone, driving a stolen vehicle, violating a toll regulation, attempting to avoid paying parking fees.

18. A computer program product, comprising a computer usable medium having a computer readable program code embodied therein, said computer readable program code adapted to be executed to implement a method for overlaying of a databar onto an image of a traffic violation event, the product including instructions for:
capturing a digital video of the traffic violation event, the video comprising a series of frames that collectively form a digital video file of the traffic violation event;
ascertaining pertinent data relevant to each frame of the video such that the data is specific to a particular moment of the violation event video, represented by the individual frame; and
overlaying the pertinent data in the form of a databar onto its respective frame, thereby creating an integrated image frame file showing an image frame having the databar overlaid thereon.

19. The computer program product of claim 18 further comprising program instructions for:
storing the pertinent data into a temporary database after it is ascertained, such that it may be formatted into a databar that is overlaid on the image frame.

20. The computer program product of claim 19 further comprising program instructions for:
overlaying the databar onto each image frame in a bottom margin of the image frame.

21. The computer program product of claim 18, further including instructions for predicting the violation prior to the capturing step.

22. The computer program product of claim 18, including instructions for encoding the captured video into a file type selected from a group of file types consisting of MPEG AVI, AVISynth, 3GPP Multimedia File, Advanced Systems Format File, Microsoft ASF Redirector File, Audio Video Interleave File, Flash Video File, Apple QuickTime Movie, MPEG-4 Video File, MPEG Video File, Real cMedia File, Flash Movie, DVD Video Object File, and Windows Media Video File.

23. The computer program product of claim 18, wherein the pertinent data includes one selected from a group of pertinent data consisting of time, location, information related to the violation vehicle or or operator, information related to the vehicle itself.

24. The computer program product of claim 18, further including instructions for, prior to the step of storing the video file, compressing the file.

25. The computer program product of claim 18, further including instructions for, after automatically overlaying and before allowing access by traffic enforcement personnel thereto, storing the integrated image frame with write protection and/or encryption.
